(19) United States
(12) Patent Application Publication
(10) Pub. No.: US 2024/0164350 A1
(43) Pub. Date: May 23, 2024

(54) Cross for Releasing One or More Birds

(71) Applicants: Wallace Boersma, Marshall, TX (US); John R Endicott, III, Marshall, TX (US)

(72) Inventors: Wallace Boersma, Marshall, TX (US); John R Endicott, III, Marshall, TX (US)

(21) Appl. No.: 18/514,037

(22) Filed: Nov. 20, 2023

Related U.S. Application Data
(60) Provisional application No. 63/426,774, filed on Nov. 20, 2022.

(51) Int. Cl. A01K 31/07

(52) U.S. Cl. CPC A01K 31/07

(57) ABSTRACT

A cross may be provided for releasing one or more birds at a ceremonial event. The cross may include one or more cages or areas for receiving the one or more birds. The cages or areas may be openable so that the one or more birds may be released in sequence, simultaneously, or in a predetermined order. The cages or areas may be opened manually to release the one or more birds; however, the cages or areas may be mechanically and/or electrically configured so that a remote control or mobile application may be used to control the release.

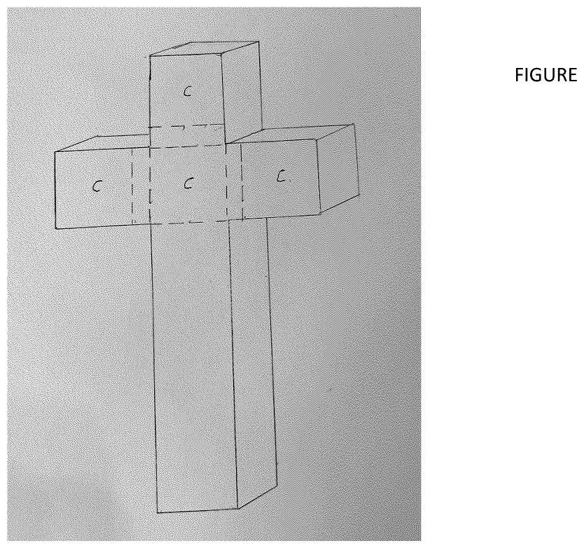

### CROSS-REFERENCE TO RELATED APPLICATION

The present application is a non-provisional of, and claims priority to, U.S. Patent Application No. 63/426,774, filed Nov. 20, 2022, the disclosure of which is incorporated by reference in its entirety.

### FIELD OF THE DISCLOSURE

The present disclosure generally relates to release of birds, and more particularly to releasing one or more birds using a cross.

### BACKGROUND

It is not uncommon for birds, particularly pigeons, to be released at ceremonial events such as a funeral or a wedding, as a sign of peace or release of the deceased spirit from the physical body. The release is accomplished by the use of one or more baskets, cages, or crates to hold the birds until the baskets, cages, or crates are opened. While decorative baskets, cages, or crates may be used in these releases, they may not be prominently positioned at the ceremonial event as other items, such as a cross or flowers, may take primary positioning relative to the participants.

### SUMMARY

Embodiments of the present disclosure may provide a cross for releasing one or more birds at a ceremonial event. The cross may include one or more cages or areas for receiving the one or more birds. The cages or areas may be openable so that the one or more birds may be released in sequence, simultaneously, or in a predetermined order in embodiments of the present disclosure. The cages or areas may be opened manually to release the one or more birds; however, the cages or areas may be mechanically and/or electrically configured so that a remote control or mobile application may be used to control the release without departing from the present disclosure.

Other embodiments of the present disclosure may provide a cross for releasing one or more birds at a ceremonial event, the cross comprising: one or more areas for receiving the one or more birds, wherein the one or more areas are openable to release the one or more birds in sequence, simultaneously, or in a predetermined order. The one or more areas may be openable manually, mechanically, and/or be electrically configured to be openable through a remote control or a mobile application. The one or more areas may be cages. The one or more birds may be homing pigeons. The one or more areas may be four cages positioned within an upper portion of the cross. The one or more areas may be of a same size. The one or more areas may be incorporated into the cross with trap doors for opening to release the one or more birds. The cross may include openings provided within the cross to receive the one or more areas, wherein the one or more areas are cages. The one or more areas may be selectively openable from a top, side, and/or bottom. The one or more areas each may receive a single bird. The one or more areas may include one or more mechanisms for ventilation. The one or more mechanisms for ventilation may be a mesh material. The cross may be selected from the group comprising: a Latin cross, a Greek cross, a Tau cross, a Tree of Life cross, an Upside Down cross, a Maltese cross, a Celtic cross, an Orthodox cross, a Coptic cross, a Golgotha cross, a Russian cross, a Papal Triple cross, an Anchor cross, or a Templar cross. The cross may be formed of one or more materials selected from the group comprising: wood, plastic, metal, mesh, and/or glass. The ceremonial event may be a funeral or a wedding. The cross may be loaded with the one or more birds prior to the ceremonial event. The one or more birds may be loaded on site at the ceremonial event. The one or more birds may be loaded prior to transport to the ceremonial event.

### BRIEF DESCRIPTION OF THE DRAWING

For a more complete understanding of this disclosure, reference is now made to the following description, taken in conjunction with the accompanying drawing, in which:

The FIGURE depicts a cross for releasing one or more birds according to an embodiment of the present disclosure.

### DETAILED DESCRIPTION

Embodiments of the present disclosure may provide a cross for releasing one or more birds. As depicted in the FIGURE, the cross may include one or more cages or areas for receiving the one or more birds. In an embodiment of the present disclosure, homing pigeons may be used for release as they may be trained to return to their home after release; however, other birds may be used without departing from the present disclosure.

The FIGURE depicts four cages (C) positioned within an upper portion of the cross. While the cages are depicted in certain positions within the FIGURE, it should be appreciated that there may be more or fewer cages or cages placed in different positions without departing from the present disclosure. Further, while the cages in the FIGURE are depicted having the same size, it also should be appreciated that the cages may be of different sizes or more than one size without departing from the present disclosure.

The cages or areas may be incorporated into or integral with the cross with trap doors or other means for opening where the one or more birds may be released. However, there may be embodiments of the present disclosure where openings may be provided in the cross for insertion and removal of cages. It should be appreciated the cages or areas may be selectively opened from the top, side, and/or bottom depending on the configuration of the cross and/or cages or areas in embodiments of the present disclosure. It also should be appreciated that the cages or areas may be opened so that the one or more birds may be released in sequence, simultaneously, or in a predetermined order in embodiments of the present disclosure. It may further be appreciated that the cages or areas may be opened manually to release the one or more birds; however, there may be embodiments of the present disclosure where the cages or areas may be mechanically and/or electrically configured so that a remote control or mobile application may be used to control the release.

As described herein and depicted in the FIGURE, it should be appreciated that one or more cages or areas may be of the same size and may each receive a single bird. However, there may be embodiments of the present disclosure where the cages or areas may be of different sizes, such as relative to the overall size of the cross in which they are placed. There also may be embodiments of the present disclosure where the cages or areas may be sized such that more than one bird may be placed within a single cage or area. The number of birds that may be released from the cross may depend on the ceremonial event itself, on the participants' preferences, the number of birds available, and/or the sizing of the cross and/or cages/areas in embodiments of the present disclosure.

The size of the cross itself may be dependent on the number of birds to be released and/or the size of the cages/areas in embodiments of the present disclosure. The cages or areas may include one or more mechanisms for ventilation while the birds are being housed within the cross. For example, a mesh material may be used as part of the cross to provide for ventilation; however, other forms of ventilation may be used without departing from the present disclosure.

In embodiments of the present disclosure, the cross may be a Latin cross, also referred to as the crucifix, which is meant to symbolize the crucifixion of Jesus Christ and showcases the passion of Jesus Christ and his death on the Cross. However, other crosses including, but not limited to, the Greek cross, Tau cross, Tree of Life cross, Upside Down cross, Maltese cross, Celtic cross, Orthodox cross, Coptic cross, Golgotha cross, Russian cross, Papal Triple cross, Anchor cross, and/or Templar cross may be used without departing from the present disclosure. It also should be appreciated that the cross may be formed of one or more materials including but not limited to wood, plastic, metal, mesh, and/or glass in embodiments of the present disclosure.

The cross according to embodiments of the present disclosure may be used at ceremonial events, including but not limited to funerals or weddings. In the context of a funeral, the release of one or more birds from the cross may represent release of the deceased spirit from the physical body. For example, the release of two birds may symbolize the departure of the deceased's spirit followed by the release of their guardian angel. The release of three birds followed by the release of a single bird may signify the Holy Trinity of the Father, Son, and the Holy Spirit guiding the soul of the deceased to heaven. In another embodiment, one bird may be released followed by the release of several birds, representing the soul of the deceased being carried by angels to heaven. In other embodiments, the number of birds released may be based on the number of immediate family members. However, there may be embodiments where the number of birds released may be based on preference of the organizers. In a funeral or wedding context, the release of one or more birds may symbolize peace, hope, and/or freedom. However, it should be appreciated that the release of birds may be for a purpose other than those described herein without departing from the present disclosure.

The cross may be loaded with one or more birds prior to the ceremonial event. It should be appreciated that the cross may be loaded with birds on site at the ceremonial event or prior to being transported to the ceremonial event in embodiments of the present disclosure. The cross may be placed at or near the ceremonial event. At the conclusion of the event, or at another time as specified by the participants, attention may be given to the cross, such as through a message describing the significance of the bird release. Upon bringing attention to the cross, the concluding act may be the bird release from the cross.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A cross for releasing one or more birds at a ceremonial event, the cross comprising:
one or more areas for receiving the one or more birds, wherein the one or more areas are openable to release the one or more birds in sequence, simultaneously, or in a predetermined order.

2. The cross of claim 1, wherein the one or more areas are openable manually.

3. The cross of claim 1, wherein the one or more areas are openable mechanically.

4. The cross of claim 1, wherein the one or more areas are electrically configured to be openable through a remote control or a mobile application.

5. The cross of claim 1, wherein the one or more areas are cages.

6. The cross of claim 1, wherein the one or more birds are homing pigeons.

7. The cross of claim 1, wherein the one or more areas are four cages positioned within an upper portion of the cross.

8. The cross of claim 1, wherein the one or more areas are of a same size.

9. The cross of claim 1, wherein the one or more areas are incorporated into the cross with trap doors for opening to release the one or more birds.

10. The cross of claim 1 further comprising:
openings provided within the cross to receive the one or more areas, wherein the one or more areas are cages.

11. The cross of claim 1, wherein the one or more areas are selectively openable from a top, side, and/or bottom.

12. The cross of claim 1, wherein the one or more areas each receive a single bird.

13. The cross of claim 1, wherein the one or more areas include one or more mechanisms for ventilation.

14. The cross of claim 13, wherein the one or more mechanisms for ventilation is a mesh material.

15. The cross of claim 1, wherein the cross is selected from the group comprising:
a Latin cross, a Greek cross, a Tau cross, a Tree of Life cross, an Upside Down cross, a Maltese cross, a Celtic cross, an Orthodox cross, a Coptic cross, a Golgotha cross, a Russian cross, a Papal Triple cross, an Anchor cross, or a Templar cross.

16. The cross of claim 1, wherein the cross is formed of one or more materials selected from the group comprising:
wood, plastic, metal, mesh, and/or glass.

17. The cross of claim 1, wherein the ceremonial event is a funeral or a wedding.

18. The cross of claim 1, wherein the cross is loaded with the one or more birds prior to the ceremonial event.

19. The cross of claim 18, wherein the one or more birds are loaded on site at the ceremonial event.

20. The cross of claim 18, wherein the one or more birds are loaded prior to transport to the ceremonial event.
